(19) United States
(12) Patent Application Publication
(10) Pub. No.: US 2023/0228549 A1
(43) Pub. Date: Jul. 20, 2023

(54) Magnetic-Inductive Wireless Detonator with Quantum Receiver

(71) Applicant: Étienne Privé, Québec (CA)

(72) Inventors: Étienne Privé, Québec (CA); Stéphane Deschenes, Québec (CA)

(21) Appl. No.: 18/007,936

(22) PCT Filed: Jun. 3, 2020
(86) PCT No.: PCT/CA2020/000085

§ 371 Date: Dec. 2, 2022

(51) Int. Cl. F42C 13/08; G08C 17/04

(52) U.S. Cl. CPC F42C 13/08; G08C 17/04

(57) ABSTRACT

A wireless detonator circuit includes a nitrogen-doped diamond quantum receiver. The nitrogen is embedded inside a diamond substrate. A light source illuminates the nitrogen-doped diamond. A number of layered optical filters, which are based on the principles of interferometry, and are in communication with the light source. One or more photodetector cells measure the quantity of photons emitted by the light source. One or more microwave antennae are located to permit even polarization of the diamond, thereby permitting magnetic field detection sensitivity in the picotesla range.

### TECHNICAL FIELD

The present invention relates to wireless detonators, and more particularly to a magneto-inductive wireless detonator having a quantum receiver.

### BACKGROUND

In the mining industry, conventional explosive detonation systems, commonly referred to as “detonators”, are generally of the electric type. Explosive charges are usually connected by means of cables to a firing system, which sends an electrical impulse, with or without delay, in order to optimize a firing plan.

A new “wireless” technology has emerged in recent years in the mining industry to optimize productivity and eliminate annoying cables. Importantly, however, while achieving its primary goal of eliminating cables, wireless technology currently in use has resulted in a significant negative collateral effect in connection with the security of operations.

There are currently two types of electronic detonators: wired and wireless. Wire detonators have two main advantages. They are extremely small and inexpensive to manufacture. On the other hand, they are very bulky, especially in mines underground, because they require a lot of winding. Hence the ever-growing industry interest in developing wireless detonators.

The current wireless detonators, called magneto-inductive, have a diameter much larger than wired detonators and they are much more expensive to manufacture. Moreover, since the diameter of the detonator is larger, the diameter of the bit, used to drill the hole to receive it, must have a directly proportional size. Consequently, the drilling process in the rock is automatically longer and more expensive.

These are the main reasons why these wireless detonators, which exist only for about five years and this without ever having, to our knowledge, been the subject of patents, are currently little used. At present, the use of the wireless detonator accounts for about 1% of the industry.

On the other hand, these magneto-inductive wireless detonators have some very important unique advantages: they are not connected to cables, they facilitate the search for metallic veins and they facilitate their own deployment.

### BRIEF SUMMARY

We have designed a wireless detonator system based on the magneto-inductive principle which uses a low-frequency magnetic field to communicate with a transmitter within a radius of more than 1 square km buried up to several tens of meters in ground. Our design uses an ultra-miniature detonator, wireless, magneto-inductive, equipped with a diamond quantum radio, doped with nitrogen. This makes it possible to detect weak magnetic fields along all axes (X, Y and Z). The quantum radio is composed of a quantum receiver allowing the miniaturization of the wireless communication system. Indeed, the most recent discoveries in quantum electronics allow for new applications in the field of wireless detonators. Our design replaces conventional three bulky single-frequency antennae with a quantum receiver. This incorporates, on the one hand, an ultra-sensitive magnetic field measurement system (picotesla), based on the micro diamond doped with nitrogen, and, on the other hand, all the other usual functions of a wireless detonator system inside one or more integrated circuits. We can now manufacture detonators at low cost without magneto-inductive wires. This new quantum receiver technology makes it possible to reduce the diameters of the detonators, which improves productivity, particularly in the mining sector when searching for metal deposits. The multifrequency quantum receiver also makes it possible to correct an important problem of zone security for operators by adding a function for this purpose hitherto non-existent in wireless detonators.

Accordingly, in one embodiment there is provided a wireless detonator circuit comprising:

a nitrogen-doped diamond quantum receiver, the nitrogen being embedded inside a diamond substrate;
a light source for illuminating the nitrogen-doped diamond;
a plurality of layered optical filters are in communication with the light source;
one or more photodetector cells are located to measure the quantity of photons emitted by the light source; and
one or more microwave antennae are located to permit even polarization of the micro diamond, thereby permitting magnetic field detection sensitivity in the picotesla range.

In one example, the light source emits light in the red range and measures the intensity of photons emitted therefrom.

In one example, the light source is a light emitting diode or a laser diode.

In another example, the optical filters are a network of metallic conductors separated by a few nanometers, the filters eliminate residual photons at 532 nm,

In one example, the circuit further includes a second microwave excitation circuit is connected so as to control the detection frequency of the magneto-inductive signal.

In yet another example, the circuit further include a third ultra-sensitive circuit located to acquire data from the photodetector cells.

In one example, a digital filter located to permit digital demodulation to be performed on the magneto-inductive signal The digital filter is a Lock-In type digital filter.

In yet another example, a processing unit in communication with the digital filter, the processing unit allows decoding and activation of an explosive charge.

In another example, the circuit further includes a redundancy processing unit.

In another example, the circuit further includes one or more supply circuits.

In another example, the circuit further includes a communication circuit having an integrated ignition system.

In one example, a detonator that incorporates a multi-frequency quantum receiver.

In one example, a detonator which contains a zone protection system using a multi-frequency quantum receiver.

In still another example, the picotesla range is less than or equal to 10 picotesla.

In yet another example, the diamond is a micro diamond.

### BRIEF DESCRIPTION OF THE DRAWINGS

These and other features of that described herein will become more apparent from the following description in which reference is made to the appended drawings wherein:

FIG. 1 is a diagrammatic representation of overall view of a wireless detonator system in an environment showing that these are installed underground in all possible axes; and

FIG. 2 is a diagram of a quantum substrate integrated in wireless detonators.

### DETAILED DESCRIPTION

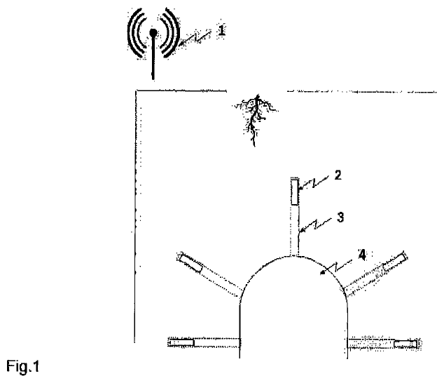

Referring first to FIG. 1, current magneto-inductive wireless detonators use powerful single-frequency surface-transmitting antennae 1 that transmit binary information using a two-frequency communication system (FSK). The information transmitted is generally firing parameters such as a “preamble”, which is used to “wake up” the detonator and select the best receiving axis, explosion delay and firing controls. A powerful mono-frequency transmitting antenna on the surface transmits its signals in a single axis due to its weight and size which can reach several meters in diameter. Detonators 2, underground, are generally placed in drilled holes 3 in any axis, especially when they are inside an underground gallery 4. The detonators must therefore be equipped with a magnetic field detection system in the three axes. All antennae (X, Y and Z) must be spaced far enough apart from each other to avoid mutual inductive interference between each of them. These antennae consist of a metal wire wound around a ferrite rod, which makes it possible to concentrate the magnetic field inside them. Each of the antennae is generally a minimum of 2 to 5 cm in diameter.

To be effective, the antennae must be perfectly tuned using a capacitor which makes it possible to create a single frequency resonant circuit. This resonant circuit makes it possible to increase the sensitivity of the antenna to obtain a very narrow frequency response in order to eliminate the sources of surrounding noise produced mainly by the electrical networks (50/60 Hz and their harmonics). A variation, even very small, of the characteristics of the antenna or the capacitor creates a frequency shift of the resonant circuit and reduces the uniformity of the gain between the detonators. In a standard firing plan, we must be able to detonate several hundred detonators in a synchronized manner over an area of more than 1 square km and up to 30 meters deep in the ground. The communication times of magneto-inductive detonators are very long due to the preamble, which can be up to more or less about fifteen seconds, which must be added to the detonation programming. The electronic circuit of the detonator must select the best reception axis (choice of antenna X, Y or Z) by scanning in order to obtain the best signal integrity. This forces the transmitter to repeat its preamble sequence at least three times before activating the exchange of commands with the detonators. It is easy to understand that these repetitions lead to considerably increased risks of difficulties in synchronizing the communication with the detonators, thereby affecting the efficiency required during such operations.

Conventional wireless detonators also pose a major security problem for personnel. Given the long range of transmitters, these detonator systems are susceptible to harmful handling errors such as activation in another zone than that intended for the firing sequence.

For example, a firing plan can be planned within a radius of 1 km at 30 meters deep in the rock, but the signals can easily be picked up by mistake beyond this zone on the surface. An operator, or group of operators, could suffer a fatal accident if a detonator was activated in an area outside the intended area. In another example, detonators activated by mistake in a truck, in an area outside the firing plan, could explode accidentally. Finally, wireless detonators also have a definitely larger environmental footprint than standard electric detonators, due to their larger size (which generates waste plastic and metals such as copper and ferrite)

For all the above reasons, the mining industry seeks to reduce the size of its wireless detonators, which currently have a minimum diameter of around 3 cm.

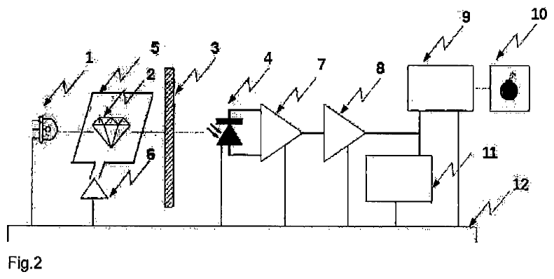

Referring generally now to FIG. 2, our wireless detonator system uses a quantum receiver based on a new magnetometer technology which includes a diamond in which certain carbon atoms are replaced by nitrogen atoms, making the structure extremely sensitive to magnetic fields. The nitrogen atoms are arranged inside the structure in such a way that one can measure any magnetic field vector inside the diamond. The detection of this magnetic field is carried out by a principle of fluorescence specific to quantum electronics. When the diamond is illuminated with a green light source (532 nm), it emerges red in color with an intensity proportional to the magnetic field passing through it. The photon intensity in the red spectrum can be measured by a phototransistor in the visible range. To measure the frequency content of the magnetic field, we polarize the diamond using a microwave field at about 2.8 GHz. This principle is called “Zeeman Effect”. It is therefore possible, using a quantum receiver, to measure the intensity of a magnetic field over a wide band varying from 0 Hz to several kHz. By slightly varying the microwave polarization, we can measure, with extreme sensitivity of ≤10 pT (picoteslas), the amplitude of the magnetic field at a given frequency, using “Lock-In” type filters. Advantageously, the quantum receiver system includes one or more integrated circuits in order, on one hand, to miniaturize the radio and, on the other hand, to reduce costs for very high-volume manufacturing.

Referring now more specifically to FIG. 2, the wireless detonator system includes a circuit 100 which includes a light emitting diode or laser diode light source 10, which illuminates a nitrogen-doped micro diamond embedded inside a diamond substrate 12. Several layers of optical filters 13, which are based on the principles of interferometry, are a network of metallic conductors separated by a few nanometers, and which create an interference pattern that eliminates residual photons at 532 nm. This provides magnetic field detection sensitivity in the picoteslas range. One or more photodetector cells 14 are located to measure the quantity of photons in the red range and to measure the intensity of photons emitted by the light source. A system of microwave antenna(s) 15 are located to permit even polarization of the micro diamond, which increases the detection sensitivity of the magnetic field in the picotesla range. A second microwave excitation circuit 16. is connected so as to control the detection frequency of the magneto-inductive signal. A third ultra-sensitive circuit 17 is located to acquire data from the photodetector cells 14. A “Lock-In” type digital filter 18 is located to permit digital demodulation to be performed on the magneto-inductive signal A processing unit 19 is in communication with the digital filter 18 to allow the decoding and activation of the explosive charge. A redundancy processing unit 102 ensures message security and prevents faults related to the malfunction of the main processing unit. One or more supply circuits 110 are connected to supply the various elements of the substrate. Finally, a communication circuit 120 with an integrated ignition system is connected to the circuit 100.

Thus, in sum, our design provides a complete, fast, economical, ecological and security to the problems created both by traditional wired detonators and by the most recent current wireless detonators. This eliminates the very bulky nature of wired detonators while retaining their main advantages, their small format and their low manufacturing cost, thanks to miniaturization. Our design miniaturizes the current format of wireless detonators by reducing the diameter by 40 to 50% while maintaining their sensitivity (≤10 picotesla). This reduced diameter help obtain significant gains efficiency by reducing drill bit diameters and, by extension, drilling time. Furthermore, we have eliminated the axis antennae and replaced them with a quantum receiver. Moreover, our design eliminates the antenna selection process, thus improving the transmission time of information between the transmitter and the detonators by the fact that the quantum magnetometer is able to measure the magnetic field in all axes simultaneously. The significant time saving which design provides, also makes it possible, at choice, either to reduce the size of the battery integrated in the wireless detonator, or to increase its autonomy while maintaining the current size. Our design further reduces the diameter of the detonator by 40 to 50%, while maintaining its sensitivity (≤10 picotesla), making it possible to reduce the diameter of the boreholes necessary to insert the detonator. This in turn makes it possible to detect several frequencies simultaneously (multiple reception frequency) by merely modulating the excitation microwave field. Finally, the design uses the multi-frequency receiver, to enormously improve the safety of the process by giving the option of temporarily deactivating the detonator in certain zones when the quantum receiver detects a pattern of predetermined signals emitted by a short-range portable protection system. This then reduces by at least 50% the negative environmental footprint related to the manufacture and use of current wireless detonators which, due to their larger size and the materials of which they are made, generate garbage plastic and metals, such as copper and ferrite, in very large quantities.

### OTHER EMBODIMENTS

From the foregoing description, it will be apparent to one of ordinary skill in the art that variations and modifications may be made to the embodiments described herein to adapt it to various usages and conditions.

What is claimed is:

1. A wireless detonator circuit comprising:
a nitrogen-doped diamond quantum receiver, the nitrogen being embedded inside a diamond substrate;
a light source for illuminating the nitrogen-doped diamond;
a plurality of layered optical filters are in communication with the light source;
one or more photodetector cells are located to measure the quantity of photons emitted by the light source; and
one or more microwave antennae are located to permit even polarization of the micro diamond, thereby permitting magnetic field detection sensitivity in the picotesla range.

2. The circuit, according to claim 1, in which the light source emits light in the red range and measures the intensity of photons emitted therefrom.

3. The circuit, according to claim 1, in which the light source is a light emitting diode or a laser diode

4. The circuit, according to claim 1, in which the optical filters are a network of metallic conductors separated by a few nanometers, the filters eliminate residual photons at 532 nm,

5. The circuit, according to claim 1, further includes a second microwave excitation circuit is connected so as to control the detection frequency of the magneto-inductive signal.

6. The circuit, according to claim 1, further include a third ultra-sensitive circuit located to acquire data from the photodetector cells.

7. The circuit, according to claim 1, includes a digital filter located to permit digital demodulation to be performed on the magneto-inductive signal

8. The circuit, according to claim 7, in which the digital filter is a Lock-In type digital filter.

9. The circuit, according to claim 1, includes a processing unit in communication with the digital filter, the processing unit allows decoding and activation of an explosive charge.

10. The circuit, according to claim 1, further includes a redundancy processing unit.

11. The circuit, according to claim 1, further includes one or more supply circuits.

12. The circuit, according to claim 1, further include a communication circuit having an integrated ignition system.

13. The circuit, according to claim 1, in which a detonator that incorporates a multi-frequency quantum receiver.

14. The circuit, according to claim 1, in which a detonator which contains a zone protection system using a multi-frequency quantum receiver.

15. The circuit, according to claim 1, in which the picotesla range is less than or equal to 10 picotesla.

16. The circuit, according to claim 1, in which the diamond is a micro diamond.
